(19) United States
(12) Patent Application Publication
(10) Pub. No.: US 2026/0320234 A1
(43) Pub. Date: Oct. 15, 2026

(54) METHOD AND SYSTEM FOR THE DECENTRALIZED VERIFICATION OF THE AUTHENTICITY AND INTEGRITY OF DIGITAL CONTENT AND THE AUTOMATIC DETECTION OF SIMILAR CONTENT

(71) Applicant: AI Solutions by Emanuele Di Rosa PhD, Warsaw (PL)

(72) Inventor: Emanuele Di ROSA, Warsaw (PL)

(21) Appl. No.: 19/464,242

(22) Filed: Jan. 29, 2026

(30) Foreign Application Priority Data
Jan. 31, 2025 (IT) 10202500001745

(51) Int. Cl. G06F 21/64; G06F 21/10; H04L 9/32

(52) U.S. Cl. CPC G06F 21/64; G06F 21/1015; H04L 9/3247

(57) ABSTRACT

One or more aspects of the present disclosure are directed to specialized software components (e.g., fingerprinting and encryption modules, parallel computing systems, indexing and comparison algorithms) that operate in a distributed environment, interfacing with content addressing networks (e.g. IPFS), decentralized databases and cryptographic key services. These technologies aim to ensure the integrity and inalterability of data, also integrating advanced machine learning approaches (multimodal models and Large Language Models) for the recognition of semantic similarities in content.

### CROSS REFERENCE TOR ELATED APPLICATIONS

The present application claims priority to Italian Patent Application No. 10202500001745, filed Jan. 31, 2025, and entitled “METHOD AND SYSTEM FOR THE DECENTRALIZED VERIFICATION OF THE AUTHENTICITY AND INTEGRITY OF DIGITAL CONTENT AND THE AUTOMATIC DETECTION OF SIMILAR CONTENT,” the disclosure of which is hereby incorporated by reference herein in its entirety for all purposes.

### TECHNICAL FIELD

The present disclosure is directed to information technologies, and more particularly to methods of verification of the authenticity and integrity of digital contents, the tracing of their origin and the identification of any similar or derivative works.

### BACKGROUND

In the landscape of solutions for the protection and verification of digital content, there are already several approaches that make use of "fingerprinting", blockchain or content addressing techniques to ensure the traceability and integrity of data:

US20160283920A1 (Fisher, Sanchez) – Describes a digital data authentication and verification system that uses blockchain technology to ensure immutable proof of existence. This document illustrates the registration of a hash on the blockchain, in order to chronologically certify the existence of a content, without requiring a trusted entity. However, its application focuses mainly on the concept of "chain of custody" for digital data, focusing on a scheme of "hashing" and storage on a distributed ledger.

"Digital Media Copyright and Content Protection Using IPFS and Blockchain" (Opuni-Boachie, Agyekum et al., Springer) – Proposes the use of IPFS and a blockchain (based on Hyperledger Fabric) to store and protect copyrights on multimedia content, using a digital content fingerprint mechanism and immutable records.

"A Blockchain and Fingerprinting Traceability Method for Digital Product Lifecycle Management" (Gonzalez-Compean et al., MDPI) – Illustrates an approach that combines a blockchain record of (online) transactions with "fingerprinting" (offline) to verify the integrity of digital products at all stages of their lifecycle. The focus is on the traceability of digital products in cloud computing and IoT contexts.

"SecureRights: A Blockchain-Powered Trusted DRM Framework for Robust Protection and Asserting Digital Rights" (Madushanka et al., arXiv) – Presents a blockchain-based Digital Rights Management (DRM) framework, which makes use of digital watermarking, perceptual "hashing," QR codes, and IPFS for the protection of intellectual property rights.

"DataSafe: Copyright Protection with PUF Watermarking and Blockchain Tracking" (Xue et al., arXiv) – Proposes a combination of watermarking and physical devices with Physical Unclonable Functions (PUFs) to constrain watermark extraction within hardware.

"AIGC-Chain: A Blockchain-Enabled Full Lifecycle Recording System for AIGC Product Copyright Management" (Jiang et al., arXiv) – Describes a system that focuses on blockchain recording of the entire lifecycle of artificial intelligence-generated content (AIGC), highlighting the need to reframe copyright management when the authoring component is partially or entirely automated.

"FingerChain: Copyrighted Multi-Owner Media Sharing by Introducing Asymmetric Fingerprinting Into Blockchain" (Xiao et al., IEEE Xplore) – Introduces a multimedia sharing model on blockchain with "asymmetric fingerprinting (watermarking)" techniques to facilitate user traceability and efficiency for owners. Emphasis is placed on controlling distribution and reducing the need for trust in third parties.

"Blockchain-based P2P multimedia content distribution using collusion-resistant fingerprinting" (Qureshi et al., IEEE Xplore) – Concerns a P2P distribution system with a collusion-proof "fingerprinting" mechanism.

EP 3 770 840 A1 (CHANNELSIGHT LTD, 2021), below D1 – Describes a system to identify duplicate products in e-commerce marketplaces through "matching" of semantic and visual vectors. However, it operates in a trusted centralized environment without cryptographic authentication mechanisms or immutable proofs, limiting itself to product "matching" and without establishing authorship or time priority.

CN 111 241 309 A (TENCENT TECH SHENZHEN CO LTD, 2020), below D2 – Proposes the storage of multimedia vectors directly on blockchain for similarity searches. This approach is inefficient for real content, especially large content, as it stores complete vectors instead of compact "hashes", without calculating a mathematical derivation of self-verifying content identifiers; moreover, it does not propose efficient multi-level architectures for storage that determine a significant technical impact.

WO 2025/024385 A1 (TRUFO INC, 2025) below D3 – Generically mentions "Content ID" and digital signature for audiovisual content. However, it does not specify a mathematical derivation of the Content ID, nor does it introduce a cryptographic link or "binding" between the identity of the author and the content, and limits itself to generating "timestamps"; moreover, it does not address the technical issue of resolving conflicts or disputes.

### SUMMARY

One or more aspects of the present disclosure are directed to specialized software components (e.g., fingerprinting and encryption modules, parallel computing systems, indexing and comparison algorithms) that operate in a distributed environment, interfacing with content addressing networks (e.g. IPFS), decentralized databases and cryptographic key services. These technologies aim to ensure the integrity and inalterability of data, also integrating advanced machine learning approaches (multimodal models and Large Language Models) for the recognition of semantic similarities in content.

The combination of perceptual "hashing" techniques, feature extraction, semantic analysis and digital signatures generates a concrete technical effect: the system allows a robust identification and registration of content in a distributed context without a centralized trusted subject. This solves the technical problem of ensuring the authenticity and traceability of digital files that may be subject to illicit copying or modification.

By virtue of these characteristics, example embodiments of the present disclosure can be applied to application in industrial areas that involve the use of computerized methodologies for the analysis and protection of multimedia data, such as the legal-forensic sector, content distribution and sharing platforms, the management of copyrights or patents, as well as all those contexts in which the production of reliable digital evidence may be warranted. Furthermore, aspects implemented through specific software modules integrated into a parallel processing system, provides a substantial technical improvement compared to traditional verification procedures.

Advantageous aspects of the present disclosure include, but are not limited to:
1. Cryptographic binding between digital signature and mathematically derived CID. Aspects of the present disclosure create a chain of cryptographic proofs where the signature authenticates the CID that incorporates fingerprints and metadata, creating an indissoluble link between identity and content, absent in all the documents cited.
2. Advanced transformation-resistant, non-invasive "fingerprinting" techniques of the content, implemented by dedicated parallel processes.

The present disclosure involves algorithms capable of recognizing content even if it is subject to substantial changes, such as image rotations, tempo variations in audio tracks or small alterations in video. This is achieved through the use of perceptual fingerprints, spectral analysis or robust feature extraction algorithms (e.g. ORB for images or specific spectrogram peak "hashing" methods for audio).
3. Self-verifying Content Identifier. The CID is mathematically derived and independently verifiable
4. Adjustable "fingerprinting" parameters

The system allows the parameters of the "fingerprinting" algorithms to be optimized, through intuitive controls or programmatic inputs, according to the type of content or the user's needs. For example, the user can adjust the sensitivity to specific transformations (JPEG compression, scaling, audio speed changes, etc.) to achieve the best compromise between accuracy and robustness.
5. Full support for heterogeneous content types

The present disclosure is not limited to a single format (image only or audio only), but provides a modular set of "fingerprinting" and semantic representation algorithms suitable for text, images, audio and video. This ensures a single, integrated platform for recording and verifying content of various kinds.
6. Searching for similar content

Thanks to the combination of traditional fingerprints and semantic "embeddings", i.e. vector representations of the semantics of a content, the present disclosure is able to identify not only exact matches, but also derived or modified content. The system calculates a similarity score and informs the user about the potential overlap or derivation from the content already recorded. This functionality of searching for related works is particularly useful for attributing authorship and checking for plagiarism or unauthorized manipulation.
7. Integration with Artificial Intelligence systems

The method involves specific APIs that allow generative AI models to autonomously record the content created (e.g., texts, AI-generated images, synthesized audio), while verifying originality against existing works. This integration allows the AI itself to "claim" the creation, in case the legislation or application scenarios require it, or to dynamically adapt the generated content to avoid conflicts of rights.
8. Secure cryptographic key management

A further distinctive aspect consists in the implementation of key management mechanisms capable of generating, importing, exporting or using cryptographic key pairs (public/private) without the private keys being stored in plaintext. This feature avoids common vulnerabilities and ensures that the digital signing of metadata and authentication of the author (or AI model) are reliably done.
9. Flexibility in storage on blockchain and/or databases
   Storing the entire file on the blockchain is optional: in one configuration, only the "hashes/fingerprints" and metadata are stored in the blockchain (ensuring transparency and inalterability), while the original file resides in a traditional database or on a content addressing system such as IPFS.
   In another configuration, it is also possible to store the content directly on the blockchain (where the file size allows it), or opt for a hybrid approach that uses databases and/or caches to speed up the search for similarities, while still maintaining the immutable proof on a distributed ledger.
   In another configuration, a multi-level "storage" architecture is implemented, where cache, IPFS and blockchain operate synergistically.
10. Efficient search for derivative content and deepfake prevention

The present disclosure adopts indexed data structures and similarity search procedures capable of reducing comparison times, ensuring effective verification of potential derivative or manipulated content.

If similarity thresholds are exceeded, the system produces a warning or report indicating the likelihood that the content is original, derivative, or a deepfake.

The present disclosure, therefore, differs and improves with respect to the known art, since it proposes a complete computer-implemented system that jointly addresses the problems of verification in trustless environments through a chain of interdependent cryptographic proofs, recognition of derived content, attribution of authorship and scalability, making use of a parallel architecture and semantic representation technologies capable of extending the scope of identification of similar content, potentially derived from the original work.

In one aspect, a method for verifying authenticity, integrity and non-repudiation of digital content and identifying similarity to existing digital content without a trusted central authority, implemented by an electronic system, includes receiving a digital content and metadata, wherein the digital content has at least one of an author or a rights holder, including automated systems; preprocessing the digital content based on a file type of the digital content, wherein the preprocessing includes performing normalization and standardization operations on the digital content to improve extraction of digital fingerprint of the digital content; generating at least one of the digital fingerprints or semantic vector representations for the digital content through parallel processing via content-specific dedicated processes, wherein the digital fingerprints or the semantic vector representation: are resistant to alterations; and include at least perceptual hashing algorithms, robust feature extraction, or semantic analysis using multimodal models or Large Language Models. The method further includes generating a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content; generating or verifying a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content; computing at least one similarity score between the digital content and existing content accessible by the electronic system by comparing the digital fingerprints or the semantic vector representations of the digital content with available digital fingerprints or semantic vector representations of the existing content, using a multi-stage approach; determining, based at least on the similarity scores, whether the digital content is identical to at least one existing content, derivative of at least one existing content, or potentially a deepfake of at least one existing content; storing the digital fingerprints, the metadata, the CID, in a configuration after being signed, or results of generating or verifying the digital content to be identical, derivative, or deepfake of the at least one existing content, on a decentralized storage system, wherein the decentralized storage system is one of a distributed database system, a blockchain, or a hybrid of a database-blockchain system, the decentralized storage system providing at least two storage levels with different access and immutability characteristics, wherein the at least two storage levels provide distributed storage for availability, and immutable registry of cryptographic proofs of available digital contents; generating an output to indicate at least one match between the digital content and the at least one existing content, the output further including at least one of the similarity scores, the author or the content holder, a declaration indicating whether the digital content is human-created or AI-generated or other metadata, or reference links to the decentralized storage system; and updating the decentralized storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

In another aspect, parameters for generating the digital fingerprints including sensitivity to one or more of resizing, compression, and audio speed variations are adjustable in order to optimize a robustness or tolerance of the digital content to specific transformations, and adjusting the parameters modifies algorithms for extraction of the digital fingerprints without altering the content itself.

In another aspect, determining whether the digital content is the identical, derivative, or deepfake of the at least one existing content comprises performing a cascade process that includes initial filtering of the digital content with sub-linear complexity to reduce candidates from among the existing content; comparing, using multiple weighted metrics, the digital content to the candidates,

identifying one or more of the candidates having at least a threshold level of similarity to the digital content as the at least one existing content; and providing an alert or a report signaling that the digital content is the identical, derivative, or deepfake of the at least one existing content.

In another aspect, at least one Application Programming Interfaces (APIs) or a Model Context Protocol (MCP) is used in association with the large language models or A2A for agent-to-agent communication, or applying other system integration or communication protocols to autonomously register created content using cryptographic identification of the model and optionally including generation parameters in attestation, to verify its originality against pre-existing works, and to declare the author, where this is permitted.

In another aspect, the method further includes securely storing cryptographic keys used for signing the digital fingerprints in a manner that avoids a plaintext storage of the cryptographic keys, using at least one of key-at-rest encryption techniques and hardware protection mechanisms.

In another aspect, the at least two storage levels with different access and immutability characteristics for storing the digital fingerprints, the metadata, the CID after being signed, or the results of determining the digital content to be identical, derivative, or deepfake of the at least one existing content, includes a first level having a cache memory for rapid access to frequently used data; a second level having a distributed storage system with replication for availability; and a third level having an immutable registry for cryptographic proofs and references, wherein the data migrates between levels based on access patterns and verification requirements.

In another aspect, the method further includes using indexed data structures and similarity search procedures with sub-linear complexity in computing the similarity scores to enable faster determination of the digital content as the identical, derivative, or deepfake of the at least one existing content, and providing a probability score indicating a degree of correspondence of the digital content to one of being identical, derivative, or deepfake of the at least one existing content.

In another aspect, when the author or rights holder does not possess a personal cryptographic key, generating the digital signature includes authenticating the author or rights holder through an identity verification mechanism comprising at least one of platform credentials with multi-factor authentication, a third-party identity provider, or a hardware-backed authentication protocol; the system generating or retrieving a cryptographic key associated with the authenticated identity of the author or rights holder; and creating a signed attestation record binding the authenticated identity to the CID, wherein the attestation record comprises at least the authenticated identity, an authentication method identifier, a timestamp, and the CID, and wherein the signed attestation record provides non-repudiation by cryptographically linking the authenticated identity to approval of the digital content.

In one aspect, a system for verifying authenticity, integrity and non-repudiation of digital content and identifying similarity to existing digital content without a trusted central authority, includes at least one storage system; at least one memory having computer-readable instructions stored therein; and at least one processor coupled to the at least one storage system and the at least one memory. The at least one processor is configured to execute the computer-readable instructions to receive a digital content and, optionally, associated metadata, wherein the digital content has at least one of an author or a rights holder, including automated systems; preprocess the digital content based on a file type of the digital content, wherein the preprocessing includes performing normalization and standardization operations on the digital content to improve extraction of digital fingerprint of the digital content; generate at least one of the digital fingerprints or semantic vector representations for the digital content through parallel processing via content-specific dedicated processes, wherein the digital fingerprints or the semantic vector representation are resistant to alterations; and include at least perceptual hashing algorithms, robust feature extraction, or semantic analysis using multimodal models or Large Language Models. The at least one processor is configured to execute the computer-readable instructions to generate a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content; generate or verify a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content; compute at least one similarity score between the digital content and existing content accessible by the system by comparing the digital fingerprints or the semantic vector representations of the digital content with available digital fingerprints or semantic vector representations of the existing content, using a multi-stage approach; determine, based at least on the similarity scores, whether the digital content is identical to at least one existing content, derivative of at least one existing content, or potentially a deepfake of at least one existing content; store the digital fingerprints, the metadata, the CID, in a configuration, after being signed, or results of generating or verifying the digital content to be identical, derivative, or deepfake of the at least one existing content, on the at least one storage system, wherein the at least one storage system includes one of a distributed database system, a blockchain, or a hybrid of a database-blockchain system, the at least one storage system providing at least two storage levels with different access and immutability characteristics, wherein the at least two storage levels provide distributed storage for availability, and immutable registry of cryptographic proofs of available digital contents; generate an output to indicate at least one match between the digital content and the at least one existing content, the output further including at least one of the similarity scores, the author or the content holder, a declaration indicating whether the digital content is human-created or AI-generated, or reference links to the at least one storage system; and update the at least one storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

In another aspect, parameters for generating the digital fingerprints including sensitivity to one or more of resizing, compression, and audio speed variations are adjustable in order to optimize a robustness or tolerance of the digital content to specific transformations, and the at least one processor is configured to adjust the parameters by modifying algorithms for extraction of the digital fingerprints without altering the content itself.

In another aspect, the at least one processor is configured to determine whether the digital content is the identical, derivative, or deepfake of the at least one existing content comprises performing a cascade process that includes initial filtering of the digital content with sub-linear complexity to reduce candidates from among the existing content, comparing, using multiple weighted metrics, the digital content to the candidates, identifying one or more of the candidates having at least a threshold level of similarity to the digital content as the at least one existing content, and providing an alert or a report signaling that the digital content is the identical, derivative, or deepfake of the at least one existing content.

In another aspect, at least one Application Programming Interfaces (APIs) or a Model Context Protocol (MCP) is used in association with the large language models or A2A for agent-to-agent communication, to autonomously register created content using cryptographic identification of the model and optionally including generation parameters in attestation, to verify its originality against pre-existing works, and to declare the author, where this is permitted.

In another aspect, the at least one processor is further configured to securely store cryptographic keys used for signing the digital fingerprints in a manner that avoids a plaintext storage of the cryptographic keys, using at least one of key-at-rest encryption techniques and hardware protection mechanisms.

In another aspect, the at least two storage levels with different access and immutability characteristics for storing the digital fingerprints, the metadata, the CID after being signed, or the results of determining the digital content to be identical, derivative, or deepfake of the at least one existing content, includes a first level having a cache memory for rapid access to frequently used data; a second level having a distributed storage system with replication for availability; and a third level having an immutable registry for cryptographic proofs and references, wherein the data migrates between levels based on access patterns and verification requirements.

In another aspect, the at least one processor is further configured to use indexed data structures and similarity search procedures with sub-linear complexity in computing the similarity scores to enable faster determination of the digital content as the identical, derivative, or deepfake of the at least one existing content, and providing a probability score indicating a degree of correspondence of the digital content to one of being identical, derivative, or deepfake of the at least one existing content.

In one aspect, one or more non-transitory computer-readable media include computer-readable instructions, which when executed by one or more processors of a system for verifying authenticity, integrity and non-repudiation of digital content and identifying similarity to existing digital content without a trusted central authority, causes the system to receive a digital content and, optionally, associated metadata, wherein the digital content has at least one of an author or a rights holder, including automated systems; preprocess the digital content based on a file type of the digital content, wherein the preprocessing includes performing normalization and standardization operations on the digital content to improve extraction of digital fingerprint of the digital content; generate at least one of the digital fingerprints or semantic vector representations for the digital content through parallel processing via content-specific dedicated processes, wherein the digital fingerprints or the semantic vector representation are resistant to alterations; and include at least perceptual hashing algorithms, robust feature extraction, or semantic analysis using multimodal models or Large Language Models; generate a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content; generate or verify a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content; compute at least one similarity score between the digital content and existing content accessible by the system by comparing the digital fingerprints or the semantic vector representations of the digital content with available digital fingerprints or semantic vector representations of the existing content, using a multi-stage approach; determine, based at least on the similarity scores, whether the digital content is identical to at least one existing content, derivative of at least one existing content, or potentially a deepfake of at least one existing content; store the digital fingerprints, the metadata, the CID, in a configuration, after being signed, or results of generating or verifying the digital content to be identical, derivative, or deepfake of the at least one existing content, on at least one storage system, wherein the at least one storage system includes one of a distributed database system, a blockchain, or a hybrid of a database-blockchain system, the at least one storage system providing at least two storage levels with different access and immutability characteristics, wherein the at least two storage levels provide distributed storage for availability, and immutable registry of cryptographic proofs of available digital contents; generate an output to indicate at least one match between the digital content and the at least one existing content, the output further including at least one of the similarity scores, the author or the content holder, a declaration indicating whether the digital content is human-created or AI-generated, or reference links to the at least one storage system; and update the at least one storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

In another aspect, parameters for generating the digital fingerprints including sensitivity to one or more of resizing, compression, and audio speed variations are adjustable in order to optimize a robustness or tolerance of the digital content to specific transformations, and the at least one processor is configured to adjust the parameters by modifying algorithms for extraction of the digital fingerprints without altering the content itself.

In another aspect, execution of the computer-readable instructions by the one or more processors further cause the system to determine whether the digital content is the identical, derivative, or deepfake of the at least one existing content comprises performing a cascade process that includes initial filtering of the digital content with sub-linear complexity to reduce candidates from among the existing content, comparing, using multiple weighted metrics, the digital content to the candidates, identifying one or more of the candidates having at least a threshold level of similarity to the digital content as the at least one existing content, and providing an alert or a report signaling that the digital content is the identical, derivative, or deepfake of the at least one existing content.

In another aspect, at least one Application Programming Interfaces (APIs) or a Model Context Protocol (MCP) is used in association with the large language models or A2A for agent-to-agent communication, to autonomously register created content using cryptographic identification of the model and optionally including generation parameters in attestation, to verify its originality against pre-existing works, and to declare the author, where this is permitted.

In another aspect, execution of the computer-readable instructions by the one or more processors further cause the system to securely store cryptographic keys used for signing the digital fingerprints in a manner that avoids a plaintext storage of the cryptographic keys, using at least one of key-at-rest encryption techniques and hardware protection mechanisms.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example method according to some aspects of the present disclosure;

FIG. 2 illustrates an example process of generating fingerprints for different types of content according to some aspects of the present disclosure; and

FIG. 3 illustrates an example system architecture for implementing example methods described herein according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The present disclosure concerns a computer-implemented method (hereinafter referred to as the "method") that allows the verification of the authenticity and integrity of digital content, as well as the detection of similar or derivative content, including any deepfake manipulations. The method is implemented by an electronic system and accessible by a user or an external software agent (software agent), according to the claims described herein.

Below is an overview of the main steps of the method, which correspond to the claims and outline a modular and scalable logical flow.

### Receiving Content and Metadata Step 100

In this first phase, the method involves receiving the digital content (it can be text files, images, audio tracks, videos or any other format suitable for processing). At the same time or optionally, any metadata provided by an author, a rights holder, or an automated system (e.g., a generative AI model) is captured. This metadata can include:
Information about the author (or the public reference key),
Declarations of authorship or creation, Information about the author (or the public reference key),
Statements on the possible AI-generated or AI-assisted nature of the content,
Timestamp or other useful information for the subsequent recording or comparison phase.

### 2. Generation and/or verification of digital signature Phase 200

In the event that the user or software agent provides a digital signature, the method applies the signature to the "Content Identifier" (CID) creating a cryptographic link between the identity of the signatory and the content, thus ensuring the authenticity of the declaration of authorship (or ownership of rights). If the user intend to record the content, he can generate a digital signature that ensures that the metadata (including the author's statement and various details) remains immutably linked to the content itself.

### 3. Preprocessing the content Phase 300

Regardless of the type of file, the method involves a preprocessing phase that adapts the content to subsequent "fingerprinting" activities. Especially:
For texts, the system can remove superfluous special characters or standardize formatting (e.g. conversion to lowercase).
For images, the system can use grayscale scaling and conversion techniques, reducing noise.
For audio tracks, the system can proceed to normalize the sample rate or filter out any background noise.
For videos, the system can extract keyframes and compress the resolution if deemed warranted. Such standardization (or normalization) allows to improve the accuracy of the "fingerprinting" algorithms (claim 1, phase c)). Parallel processing takes place through dedicated processes for each type of content, allowing simultaneous processing instead of sequential processing, which is essential for industrial performance.

### 4. Parallel generation of fingerprints and semantic representations Phase 500

Once the content is prepared, the method runs a plurality of "fingerprinting" algorithms in parallel, some of which are designed to be resistant to transformations such as rotations, variations in time or small alterations (claim 1, phase d)). By way of example:
perceptual "hashing" (pHash, dHash, aHash),
Feature extraction (e.g., image ORBs),
Spectrogram peak "hashing" for audio signals,
"hashing" and keyframe analysis for videos.

In addition to traditional fingerprints, a semantic "embedding" is generated through multimodal models or Large Language Models (LLMs) suitable for capturing similarities in meaning between apparently different contents. In this way, a set of descriptors ("fingerprint" and "embedding") is obtained that can represent the content in a complete way, both from a perceptual and semantic point of view.

### 5. Calculating Similarity Scores Phase 600

In the case of a comparison or registration operation with pre-verification, the method calculates similarity scores by comparing the newly generated fingerprints and/or embeddings with those already existing in the archive. In particular, the presence of indexed data structures and similarity search procedures (claim 8) allows to drastically reduce comparison times.

If the content is identical to or above a defined similarity threshold, the user (or software agent) is notified of the existence of potentially the same or derivative content. The calculation uses a multi-stage approach: initial filtering to reduce candidates, detailed comparison with weighted metrics, and forensic analysis for high similarities.

If no meaningful matches are found, the content is considered "unique", allowing the author to continue with the eventual phase of definitive registration.

### 6. Generating a Content Identifier (CID) and Storing Step 700

If the user (or software agent) decides to register the content, the system generates a Content Identifier (CID), mathematically derived from the content fingerprints and/or metadata, constituting a self-verifying reference that allows anyone to verify the integrity without access to external databases. This CID serves as a unique and immutable reference for locating or identifying content in a content addressing system (claim 1, step f)).

Once the CID has been produced, the system stores the fundamental information in the database and/or on a decentralized network (IPFS, blockchain):
Fingerprints
signed metadata,
semantic “embedding”,
CID
timestamps and additional traceability data.

This step (700) ensures the persistence and immutability of the information, as the user can choose to save (claim 7):
only hashes and metadata on the blockchain, with the file elsewhere,
the entire content on the blockchain (if the size allows it).

A hybrid solution with traditional database and blockchain for the immutability of evidence.

### 7. Deliverability and feedback Phase 800

Once the comparison or registration phase is complete, the method returns a response (claim 1, phase h)) to the user or software agent. Possible cases include:

Verification scenario: list the content already recorded with similarity scores above a threshold, also providing information on author, timestamp, digital signature, link to the CID on IPFS or on the blockchain.

Registration scenario: Provide confirmation of storage and, if requested, details of any similar content already present (optionally reported in step 5 if the author wishes a pre-check).

### 8. Managing Updates, Conflicts, and Disputes Phase 900

In a dynamic context, the author or others can update signed metadata (for example, to declare a license change, add notes, or transfer ownership). Similarly, conflicts may arise if a second entity attempts to register similar content as its own.

The method immutably stores any variation, so as to provide historical evidence (timestamps and digital signatures) that facilitates the resolution of any disputes. In one configuration, it implements multi-factor conflict resolution based on signature validity, blockchain-verified time precedence, and similarity analysis, which enable deterministic resolution of complex disputes.

The evidence ("fingerprint", hash, signatures, CID) guarantees cryptographic traceability, allowing legitimate authorship or use in accordance with the law to be established.

The method and system allow for distributed trustless verification, i.e. an independent verification where two parties who do not trust can validate authenticity: one party records the content by obtaining a signed CID stored on the blockchain, the other can independently verify by recalculating the CID and verifying the signature, without the need for a trusted central authority.

In one implementation, the architecture of the present disclosure includes:
Consensus-enabled multi-node distributed system
Parallel processing on clusters (potentially GPU-accelerated)
End-to-end encryption with mathematical "binding"
Multi-level storage with "blockchain" for immutability
Mathematically derived and self-verifying Content Identifiers

These differences are not mere optimizations but essential requirements deriving from the different technical problem faced.

The distinctive features of the present disclosure have a strong synergistic effect that makes them interdependent and effective for the functioning of the overall system.

The four interdependent characteristics identified as distinctive cannot be considered separately since they form an integrated system:
f1 - Digital signature with cryptographic binding:
   The digital signature implementation described herein is not a simple validation but the first link in a cryptographic chain that creates an indissoluble mathematical bond by signing the CID (derived from fingerprint and metadata) through the signature of the CID itself. Without this, the chain of successive proofs loses its anchorage to the identity of the creator. This cryptographic bond:
      Makes it impossible to retroactively alter the content-author association
      Provides non-repudiable proof of the declaration of paternity
      Enable independent verification without access to centralized databases
      Allows computational efficiency by signing only the CID (e.g. 32 bytes) instead of the full content It is the foundation on which the distributed trust architecture rests
f2 - Mathematically derived Content Identifier:
   The CID is not a simple identifier but a cryptographic proof of the existence and integrity of the content:
      Mathematical derivation: CID = Hash(fingerprint, metadata) or fingerprint in another implementation
      Self-verifiability: anyone can recalculate and verify the CID
      Immutability: Any modification invalidates the original CID
f3 - Multi-Tier Decentralized Storage:
   The storage architecture is not an implementation choice but a requirement to ensure: Availability: Replication to at least 3 IPFS nodes Immutability:
      Merkle's roots on blockchain Performance: Distributed cache for fast access
      Verifiability: Anyone can access blockchain proofs
f4 - Multi-Factor Conflict Resolution:
   The conflict resolution system synergistically exploits all the previous features:
      Verify digital signatures (f1) for authenticity
      Compare CID (f2) for Integrity
      Access immutable trials (f3) by precedence
      Calculate similarity to identify leads

The synergistic combination produces technical effects that cannot be obtained from the individual characteristics:
"Trustless End-to-End" verification, i.e. The system allows two parties who do not trust each other to independently verify the authenticity of a content:
   1. Part A generates or provides input content and records it
      Calculate Content Fingerprint
      Derive CID = Hash (fingerprint || metadata) or as fingerprint
      Sign the CID with the user private key
      Gets bundles (CID, signature, fingerprint, metadata)
   2. The system stores, for example, as follows:
      Database: fingerprint for quick searches (cache)
      Blockchain: Signed CID + metadata hash + timestamp
      IPFS: Full content (optional) with CID as a reference
   3. Part B can independently verify:
      Compute fingerprint from received content
      Recalculate CID = Hash( fingerprint || metadata) or fingerprint
      Verify that the calculated CID matches the registered one
      Verify the signature of the CID on blockchain with public key of A
      Check timestamp for time precedence
In the event of a dispute, the method resolves (f4) based on:
   Mathematical validity of the proof chain
   Blockchain-verified time precedence
   Similarity analysis to identify leads
This flow is impossible without all the features operating synergistically.
The method also allows the following scenario of anteriority tests without knowledge ("Zero-Knowledge") to be realized. The combination of features allows the user to try time priority without revealing the content:
   1. The author at time T1:
      Compute fingerprint(content)
      Generate CID = Hash (fingerprint || metadata)
      Sign the CID
      Register on blockchain: Signed CID + T1 timestamp
   2. Privately Store:
      The original content (not revealed)
      The fingerprint (not revealed until the dispute)
   3. In the event of a future dispute, the user can try:
      To own the content that generates that specific fingerprint
      That CID = Hash (fingerprint || metadata) corresponds to the one recorded
      That the registration took place at time T1 (verifiable on blockchain)
      All this without having to publicly reveal the original content
      Only in dispute does it reveal fingerprint for verification, not the content

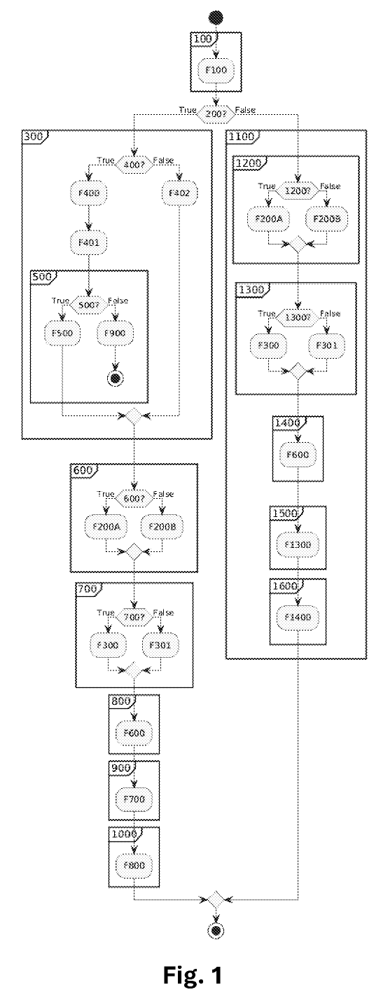

FIG. 1 illustrates an example method according to some aspects of the present disclosure. More specifically, FIG. 1 illustrates an example "Activity Diagram" describing the main flow of aspects of the present disclosure, divided into macro-phases.

Below is the legend of the labels:
100 → Receiving content and metadata.
200 → Choice between registration and verification.
300 → Pre-check similarity.
400 → Calculation of similarity and return of score.
500 → User decision whether to register anyway.
600 → Digital signature (optional).
700 → Preprocessing (optional).
800 → Fingerprint generation and "embedding".
900 → storage (DB/IPFS/Blockchain).
1000 → Registration outcome.
1100 → Verification scenario.
1200 → Verification of digital signature (if present).
1300 → Preprocessing for verification (optional).
1400 → Fingerprint generation for comparison.
1500 → Comparison with archive.
1600 → Result of the check with information on author, CID and similarity.

This figure represents the general flow of the method, distinguishing between the two main scenarios: registering new digital content and verifying the authenticity or similarity of existing content.

### Process Steps

### (100) Content Reception and Metadata

The user or an external system sends a digital file accompanied by metadata (e.g., declared author, date of creation, information on any AI-assisted generation).

The system receives this data and begins processing.

### (200) Choice of scenario: registration or verification

The system determines whether the content should be recorded (i.e., stored with a unique identifier) or verified (i.e., compared with content already existing in the database).

### Recording Scenario

If the user chooses to record content, the process follows these steps:

### (300) Pre-check Similarity (Optional)

When enabled, the system performs a quick check to determine if the content is already present or if similar content exists.

This is done by generating quick fingerprints and comparing them with stored ones.

### (400) Calculation of similarity and return of score

The system calculates a similarity score and shows it to the user.

If the content is too similar to an existing one, the user can decide whether to proceed with the registration or stop the process.

### (500) User's decision

If the user decides to stop recording, the process ends.

If the user chooses to register anyway, the system proceeds with the next steps.

### (600) Digital Signature (Optional)

If required, the system generates and digitally signs the content metadata using the user's private key.

If a signature is not required, the system continues without signing.

### (700) Preprocessing (Optional)

Content can be normalized (e.g., image resizing, audio conversion, removal of special characters in texts) to improve the quality of "fingerprinting."

### (800) “fingerprinting” ed “embedding”

The system generates a unique digital fingerprint for the content, using advanced techniques such as perceptual hashing, feature extraction or semantic "embedding".

This "fingerprint" allows recognition even in the event of slight changes or derivations of the content.

### (900) Database/IPFS/Blockchain Storage

The fingerprint is stored along with the metadata.

Depending on the configuration, the hash can only be saved in a local database, on blockchain to ensure immutability, or on IPFS to ensure a decentralized system.

### (1000) Registration Outcome

The system returns a unique identifier (CID) and confirmation of registration.

The user receives a report with all the information stored.

### Verification Scenario

If, on the other hand, the user chooses to verify content, the flow develops as follows:

### (1200) Signature Verification (if any)

If the content is digitally signed, the system verifies the authenticity of the signature before continuing.

### (1300) Preprocessing (Optional)

If warranted, the content is normalized before the "fingerprint" is generated.

### (1400) “fingerprinting” and “embedding”

The system generates a digital fingerprint and a semantic "embedding" for the content to be verified.

### (1500) Comparison with the Archives

The system compares the generated fingerprint with those in the database.

### (1600) Outcome of the Audit

If an exact match exists, details about the author, date of registration, and CID are returned.

If a similarity is found above a threshold, the system shows the similarity score and suggests that the content may be derived or manipulated.

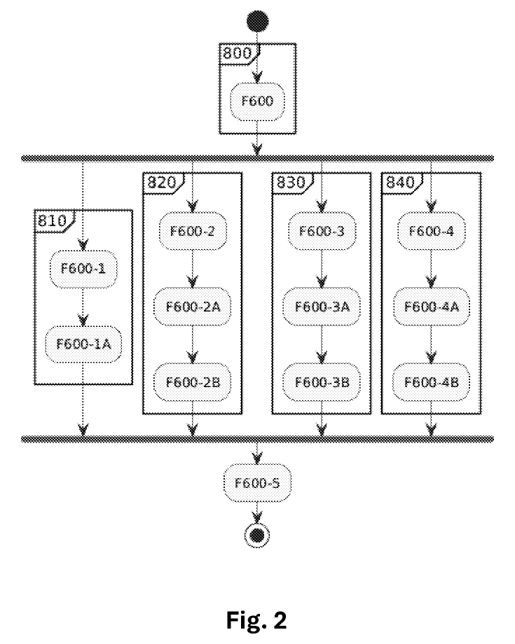

FIG. 2 illustrates an example process of generating fingerprints for different types of content according to some aspects of the present disclosure. More specifically, FIG. 2 illustrates an example "Activity Diagram" of the F600 phase "Fingerprinting" Parallel - parallel process of generating fingerprints for different types of content.

Below is a legend of the labels:
800 → Start of "fingerprinting" and "embedding".
810 → "fingerprinting" text.
820 → "fingerprinting" images.
830 → “fingerprinting” audio.
840 → “fingerprinting” video.
850 → Aggregation of results before storage.

This figure details the semantic "fingerprinting" and "embedding" phase (F600), which is performed in parallel for the different types of digital content.

### Process Steps

### (800) Initiation of the fingerprinting and embedding process

After preprocessing, the system begins generating fingerprints.

Parallel processing for each type of content - The system simultaneously processes "fingerprinting" for text, images, audio and video, with methods specific to each format:

### (810) Text

A textual fingerprint is generated based on hashes and shingling techniques.

A semantic "embedding" is calculated with NLP models (e.g. LLM).

### (820) Images

Generating perceptual hashes such as pHash, dHash, aHash.

Feature extraction with ORB for advanced comparison.

Visual "embedding" calculation with models such as CLIP.

### (830) Audio

Generation of audio "fingerprints" based on peak "hashing" of the spectrogram.

Audio embedding calculation for semantic recognition.

### (840) Videos

Extraction of representative keyframes.

Hash generation for keyframes and audio fingerprints.

Multimodal embedding calculation to analyze visual and sound content in combination.

### (850) Aggregation and Output

After parallel processing, the results are aggregated to be stored in the database or on blockchain/IPFS.

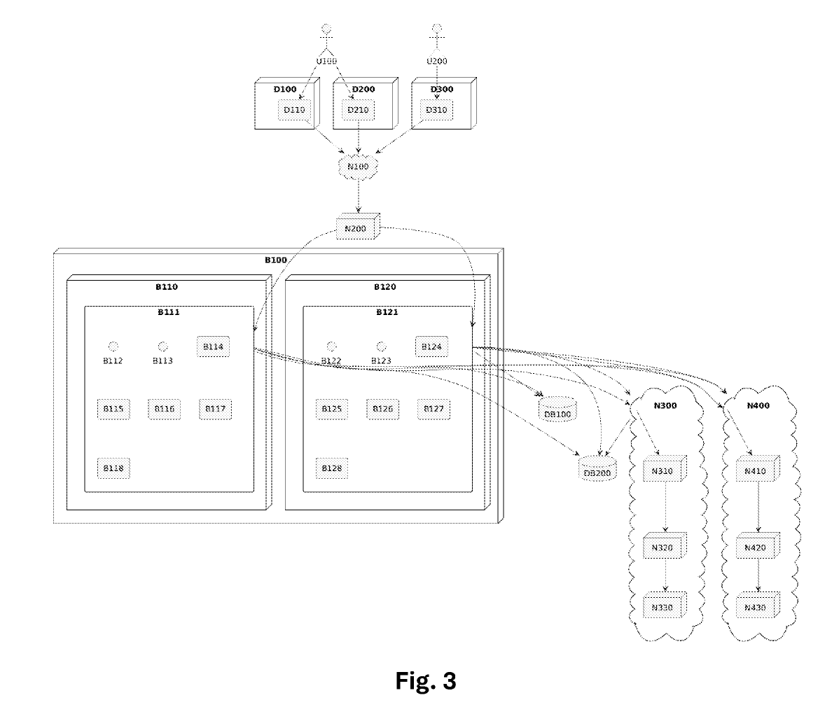

FIG. 3 illustrates an example system architecture for implementing example methods described herein according to some aspects of the present disclosure.

Below is a legend of the labels:
U100 → Human User
U200 → External System
D100 → User Device (Web)
D110 → Frontend Web App
D200 → Mobile Device
D210 → App Mobile
D300 → Dedicated device for external system
D310 → Client API for External System
N100 → Wide area network (Internet)
N200 → Load Balancer
B100 → Cluster in Backend Server
B110 → Backend Server 1
B111 → FastAPI API (Server 1)
B112 → Registration Interface (Server 1)
B113 → Verification Interface (Server 1)
B114 → Fingerprinting Module (Server 1)
B115 → Digital Signature Module (Server 1)
B116 → IPFS Client Module (Server 1)
B117 → Similarity Module (Server 1)
B118 → Cache (Server 1)
B120 → Backend Server 2
B121 → FastAPI API (Server 2)
B122 → Recording Interface (Server 2)
B123 → Verification Interface (Server 2)
B124 → Fingerprinting Module (Server 2)
B125 → Digital Signature Module (Server 2)
B126 → IPFS Client Module (Server 2)
B127 → Similarity Module (Server 2)
B128 → Cache (Server 2)
DB100 → Distributed Database (Content Store)
N300 → IPFS Network
N310 → IPFS Node 1
N320 → IPFS Node 2
N330 → N IPFS Node
N400 → Rete Blockchain
N410 → Nodo Blockchain 1
N420 → Nodo Blockchain 2
N430 → N Blockchain Node
DB200 → Database metadati IPFS

The architectural diagram illustrates the entire system designed for the decentralized recording and verification of the authenticity of digital content, supporting both human users and external systems. The architecture is tiered to ensure scalability, security, and reliability.

### Main Components

### 1. Actors and Devices

U100 (Human User) logs in via D110 (Frontend Web App) or D210 (Mobile App).

U200 (External System) uses D310 (Client API) to interface with the system programmatically.

Users and external systems connect via N100 (Internet - Wide Area Network).

### 2. Load Balancer and Distributed Backend

N200 (Load Balancer) routes traffic between backend servers, ensuring load distribution and scalability.

The B100 (Backend Server Cluster) is composed of multiple instances to manage logging and auditing:

B110 (Backend Server 1) e B120 (Backend Server 2)

Each server includes APIs for operations management (B111, B121), modules for "fingerprinting" (B114, B124), digital signature (B115, B125), caching (B118, B128) and communication with IPFS and blockchain.

### 3. Distributed Database

DB100 (Content Archive) stores fingerprints, CIDs and metadata for quick searches.

DB200 (IPFS Metadata Database) associates CID with metadata registered on IPFS.

### 4. Decentralized Network (IPFS and Blockchain)

N300 (IPFS Network) stores content in a distributed manner.

N400 (Blockchain Network) stores immutable transactions related to fingerprints and CIDs.

Content uploaded to IPFS is replicated across multiple nodes (N310, N320, N330) to ensure redundancy and availability.

Blockchain transactions are propagated between nodes (N410, N420, N430) to ensure security and traceability.

Workflow:
1. The user or external system uploads content for registration or verification.
2. The backend generates "fingerprints" and checks the similarity with the existing archive.
3. If the content is new, it is saved on IPFS (N300) and recorded on Blockchain (N400).
4. If the content already exists, the system returns the CID and registration details.
5. The user receives a report with information about registration and similarity to other content.

The method, as shown in FIGS. 1-3, is designed to ensure the authenticity, integrity, and verification of digital content using advanced fingerprinting, semantic representation generation, and digital signature techniques. The method is designed to be implemented in distributed and decentralized systems, combining storage on decentralized file networks, blockchains, and distributed databases, with caching capabilities to optimize performance.

The method involves two main scenarios:
Registration of digital content, which allows the user to generate and store a unique "fingerprint" to ensure authenticity and inalterability.
Authenticity and similarity verification, which allows the user to compare content with existing content and determine its provenance or derivation.

Both scenarios start with Content Reception (F100), in which a user or an external system transmits a file through a web interface or API. The backend (B110, B120) handles the request and initiates the processing operations.

If the content is registered, the system performs an optional Pre-Check Similarity phase (F400) to check for the existence of similar content. If a match with a high similarity score (F401) is found, the user can choose to proceed or stop recording.

In the event that the user decides to register the content, the "fingerprinting" and "embedding" phase (F500) is started, in which fingerprints ("hashes") and semantic representations of the file are calculated. Processing is performed in parallel to optimize processing times.

After the fingerprint generation, the system proceeds with the Storage (F700). Content can be stored on a decentralized network 20, obtaining a CID (Content Identifier), while the "fingerprint" and associated metadata are saved in the distributed database 40 and, if applicable, in the immutable verification network 30, ensuring transparency and immutability of the data.

Finally, in the Registration Outcome phase (F800), the system returns a registration report, containing the CID of the content, the "fingerprint" generated and the hash of the metadata saved on the blockchain.

In the case of an authenticity check, the content is processed following the same steps up to "fingerprinting" and "embedding" (F500). Subsequently, in the Comparison with Archive phase (F600), the system calculates a similarity score between the content and the existing ones. The result is presented to the user in the Verification Result phase (F800), with information on any corresponding contents, author and CID.

One of the distinctive elements of Process 1 is the use of advanced semantic "fingerprinting" and "embedding" techniques, optimized for each type of digital content.

"fingerprinting" of Text Content (F500-1):
the text module (F500-1) uses a shingling-based approach and n-dimensional "hashing" to generate a fingerprint that is resistant to word changes, paraphrasing, and rephrasing. Semantic "embedding" (F500-1A) is generated using transformer language models, which produce numerical vectors representative of the meaning of the text. This approach makes it possible to identify texts with similar content even if they are written in different forms.

Image "fingerprinting" (F500-2):
the image module (F500-2) implements a combination of perceptual "hashes" and extraction of visual features, allowing to detect cropped, rotated images or with minimal color variations. Perceptual "hashes" (F500-2), such as pHash, dHash, and aHash, allow the user to generate a unique "fingerprint" for the image. ORB-based feature extraction (F500-2A) detects points of interest and allows for more detailed comparisons between similar images. Visual "embedding" (F500-2B) is calculated using multimodal models such as CLIP, which allow the system to identify similarities between images based on the meaning of the content.

Audio "fingerprinting" (F500-3):
the audio module (F500-3) generates "fingerprints" based on spectral analysis and "hashes" of acoustic characteristics, ensuring resistance to changes in format or quality.

The spectrogram analysis (F500-3A) allows the identification of audio components that are invariant with respect to compression.

The "fingerprint" based on "spectrogram hashing" (F500-3A) generates a unique binary sequence.

Audio "embedding" (F500-3B) is calculated using neural networks trained on large datasets of audio content, allowing comparison between music or vocal tracks.

Video "fingerprinting" (F500-4):
The video module (F500-4) combines "fingerprinting" on visual and audio components to ensure reliable recognition. Keyframe extraction (F500-4) selects the most representative frames. Perceptual "hashes" and audio "fingerprints" (F500-4A) provide robustness against compression or format variations. Multi-mode embedding (F500-4B) combines audio and video, allowing similar scenes to be detected even with partial changes. Audio and video content presents particular technical challenges in "fingerprinting" and semantic analysis, as it can undergo substantial changes without significantly altering its perception (e.g., variations in tempo or equalization for audio, and compression or modification of frames for video).

Fingerprinting Techniques for Audio Content (F500-3):
the audio module (F500-3) is designed to process sound tracks, such as music, voice recordings and environmental signals, generating a unique and transformation-resistant representation.

a) Salient Acoustic Extracts and Spectrogram (F500-3A)

The first step involves converting the audio signal into a time and frequency representation using spectrogram analysis. The signal is divided into time windows, and for each window a frequency-time representation is extracted using the Short-Time Fourier Transform (STFT). This technique allows the system to identify unchanged components of the sound even if the file has been changed in speed, equalized or compressed.

b) Spectrogram Hashing and Peak Spectra Hashing (F500-3A)

After transformation into a spectrogram, the system "hashes" the salient acoustic characteristics, extrapolating the spectral energy peaks and encoding them in a binary sequence that represents the acoustic structure of the content. The most effective methods used at this stage include:
"Locality Sensitive Hashing" (LSH) to compare similar audio structures without having to calculate a Euclidean distance between vectors.
"Peak matching" algorithms, which compare only the most salient frequencies of the spectrum, ensuring resistance to changes in volume or equalization.

c) Semantic embedding for Audio Content (F500-3B):

In addition to acoustic "hashes", the system generates an audio "embedding" to capture the semantic structure of the sound content. This technique is particularly useful for identifying similarities between audio tracks even in the presence of structural changes.

To generate the "embedding", the system uses:

Neural models based on contrastive learning, such as Wav2Vec or YAMNet, which produce a high-dimensional representation of the audio signal, identifying phonetic and timbral patterns.

Convolutional neural networks (CNNs) applied directly to the spectrogram, to extract relevant features independent of the time domain.

The audio "embeddings" are then indexed and compared with those already present in the database, allowing the system to detect plagiarism, variations of recordings and artificial manipulations.

Fingerprinting Techniques for Video Content (F500-4):

The video module (F500-4) adopts a hybrid strategy, combining visual and audio "fingerprinting" to ensure reliable identification even in the presence of structural changes or video compressions.

a) Keyframe extraction (F500-4)

The first step is the automatic extraction of keyframes, i.e. the most representative frames of the video content. The algorithm selects redundant frames and extracts only the most distinctive ones, based on:
Edge Detection and Histogram Difference, which detect significant variations in image content.
Shot Boundary Detection (SBD) to identify points of discontinuity between different scenes.

This technique reduces the amount of data processed by keeping only the frames that are essential for "fingerprinting."

b) Generation of Perceptual "Hashes" and Visual Features (F500-4A)

For each extracted keyframe, the system calculates a digital signature using perceptual "hashes" and advanced visual features:
pHash and dHash to compare visual content even when compressed.
ORB (Oriented FAST and Rotated BRIEF) and SIFT (Scale-Invariant Feature Transform) to detect and compare points of interest in images.

The set of these "hashes" allows the system to identify modified or manipulated scenes, such as crops, resizes or alterations in brightness.

c) Combined Audio-Video "fingerprinting" (F500-4A):
in addition to keyframes, the audio "fingerprinting" of the video is extracted and compared to the database, using the same audio "fingerprinting" techniques described in the F500-3A.

If a video is visually edited but retains the same audio track, the system can still detect the lineage, increasing the accuracy of the verification.

d) Multimodal “embedding” (F500-4B)

To identify similarities between edited videos, the system generates a multimodal "embedding", combining information extracted from images and audio.

The "embedding" is calculated using:
Pre-trained models such as CLIP, which combine images and text in a shared space.
Fusion Networks, which combine features extracted from keyframes and audio spectrograms to obtain a unique profile for each video.

This method allows the system to detect derivative videos, deepfakes, or advanced manipulations, even if the changes only affect certain aspects of the original content.

### Verification Strategies for Multimedia Content

the techniques described are also applied in the Comparison with Archive phase (F600), allowing in-depth checks to be carried out to determine:
a) Exact match - The content is identical to one that has already been registered.
b) High similarity - The content is a modified variant of an existing file.
c) No match - The content is new and not present in the system.

In addition, in the Verification Outcome phase (F800), the user receives detailed information on the origin of the file, the original author and the similarity score with respect to the content already recorded.

Note that the method and system here disclosed can also serve users without personal cryptographic keys to digitally sign or approve digital content. The present disclosure can overcome such limitation by providing a delegated attestation mechanism that preserves non-repudiation guarantees through cryptographic binding of authenticated user identity to the content. In accordance with one aspect of the invention, when a user does not possess a personal cryptographic key pair, the method and system may provide an alternative signing pathway comprising identity verification, delegated key management, and attestation record generation.

The system authenticates the user through one or more identity verification mechanisms. In a preferred embodiment, the system supports multiple authentication methods to accommodate varying levels of security requirements and user capabilities. These methods include, but are not limited to:
(a) Platform credentials with multi-factor authentication, wherein the user authenticates using a username and password combination supplemented by a second authentication factor, such as a one-time code delivered via SMS or email, a time-based one-time password (TOTP) generated by an authenticator application, or a push notification to a registered mobile device;
(b) Third-party identity providers implementing federated authentication protocols, such as OAuth 2.0 or OpenID Connect (OIDC), wherein the user authenticates through a trusted external service and the system receives a cryptographically signed identity token attesting to the user's authenticated identity;
(c) Hardware-backed authentication protocols, such as WebAuthn or FIDO2, wherein the user authenticates using a cryptographic credential stored in secure hardware on the user's device, typically protected by biometric verification (e.g., fingerprint recognition, facial recognition) or a local PIN.

### Delegated Key Management

Upon successful authentication, the system generates or retrieves a cryptographic key associated with the authenticated identity of the user. In one embodiment, the system maintains a dedicated key pair for each registered user, with the private key stored in encrypted form using key-at-rest encryption techniques or within a hardware security module (HSM). In an alternative embodiment, the system maintains a platform signing key and generates user-specific attestations that incorporate the verified user identity.

The user is not required to generate, store, or manage any cryptographic keys. All key management operations are performed by the system on behalf of the user, thereby eliminating the adoption barriers associated with conventional digital signature schemes.

### Attestation Record Generation

The system generates a signed attestation record that cryptographically binds the authenticated user identity to the Content Identifier (CID) of the digital content. The attestation record comprises at least the following elements:
(a) The authenticated identity of the user, derived from the identity verification mechanism;
(b) An authentication method identifier indicating the mechanism used to verify the user's identity;
(c) A timestamp indicating the date and time at which the user approved the digital content;
(d) The Content Identifier (CID) of the digital content being attested; (e) A digital signature generated by the system using the cryptographic key associated with the user's authenticated identity.

The signed attestation record provides non-repudiation by establishing a cryptographic link between the authenticated identity of the user and the user's approval of the specific digital content identified by the CID. The attestation record may be verified by any party having access to the corresponding public key, thereby enabling independent verification of the user's approval without requiring trust in the platform beyond the initial identity verification.

### Audit Trail

In a preferred embodiment, the system maintains an immutable audit trail recording each attestation event, including the authentication method used, the timestamp, the CID, and metadata sufficient to reconstruct the chain of custody. This audit trail may be stored on a blockchain or other distributed ledger to provide tamper-evident logging of all attestation events.

The delegated attestation mechanism of the present invention provides several advantages over conventional digital signature schemes:
(a) Users without technical expertise can digitally sign or attest to digital content without generating or managing cryptographic keys;
(b) The system preserves non-repudiation guarantees by cryptographically binding authenticated user identity to the content;
(c) The system supports multiple identity verification mechanisms, enabling flexible deployment across varying security contexts;
(d) The system eliminates the risk of private key loss by users, as all key management is performed by the platform;
(e) The system enables broad adoption of digital content authentication by removing the primary barrier to entry for non-technical users.

The method, as described and illustrated in FIGS. 1-3, can be implemented in a system architecture 10 that enables the recording and verification of digital content in a scalable and secure manner. The architecture is designed to support both 110 individual users, 120 mobile devices, and 130 external systems, allowing efficient management of content through decentralized distribution, caching and archiving technologies.

Architecture 10 is composed of several interconnected modules, each with specific functionalities in the processing, storage and verification of digital content.

### General Structure of Architecture 10

Architecture 10 can be divided into five main components, each of which corresponds to a specific phase of the method:
User Interface and API Access
Fingerprint and embedding processing module
Digital Signature and Authentication
Decentralized Storage and Blockchain
Distributed Database and Caching

Each component is optimized for scalability, security, and reliability, allowing the system to handle a high volume of concurrent requests.

### User Interface and API Access

110 users and 130 external systems access the 10 architecture through several devices connected through a 150 wide area network. The infrastructure includes:
User device 110: Web application accessible from a browser.
Mobile Device 120: Native mobile app for Android and iOS.
Dedicated device 130: Industrial or DRM systems for registration/verification automation.

Logging and verification requests are handled by a 140 load balancer, which distributes traffic across the backend servers (B110, B120), optimizing performance and ensuring redundancy.

The system supports REST APIs and WebSockets, enabling efficient communication with third-party software for automated recording and bulk verification of digital content.

Fingerprint and embedding processing module:
the "fingerprinting" and "embedding" module 170 manages the F500 phase and operates in parallel for the analysis of different types of content.

The processing takes place in the following sub-modules:
Text Module 171: Generate semantic fingerprints and embeddings for textual documents.
Image Module 172: Computes perceptual hashes and visual features.
Audio Module 173: Performs spectrogram-based "fingerprinting" and "spectrogram hashing".
Video Module 174: Extracts keyframes and generates combined audio-video fingerprints.

The architecture supports processing on GPU/TPU, optimizing the calculation of semantic representations.

### Digital Signature and Authentication

Digital Signature Form 180 is responsible for managing the F200 phase, including:
Generation of the digital signature (F200A) with ECDSA and RSA-4096 cryptographic algorithms.
Signature verification (F200B) to authenticate the content author.

The digital signature is associated with the metadata of the content, ensuring authenticity and integrity.

### Decentralized Storage and Blockchain

200 decentralized storage and 210 immutable verification network ensure that recorded content is immutable and verifiable over time.
IPFS (200) or similar: Used for decentralized storage, assigning each file a unique CID.
"Blockchain" (210): Records "fingerprint" and metadata to ensure transparency and inalterability.

The F700 phase coordinates the entry of information on these platforms and returns the CID and fingerprint to the user.

### Distributed Database and Caching

To improve system performance, the 220 distributed database stores fingerprints and embeddings, while the 230 caching module optimizes the speed of frequent checks.

This combination allows the user to run queries at scale without compromising system latency.

1. A method for verifying authenticity, integrity and non-repudiation of digital content and identifying similarity to existing digital content without a trusted central authority, implemented by an electronic system, the method comprising:
receiving a digital content and metadata, wherein the digital content has at least one of an author or a rights holder, including automated systems;
preprocessing the digital content based on a file type of the digital content, wherein the preprocessing includes performing normalization and standardization operations on the digital content to improve extraction of digital fingerprint of the digital content;
generating at least one of the digital fingerprints or semantic vector representations for the digital content through parallel processing via content-specific dedicated processes, wherein the digital fingerprints or the semantic vector representation:
are resistant to alterations; and
include at least perceptual hashing algorithms, robust feature extraction, or semantic analysis using multimodal models or Large Language Models;
generating a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content;
generating or verifying a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content;
computing at least one similarity score between the digital content and existing content accessible by the electronic system by comparing the digital fingerprints or the semantic vector representations of the digital content with available digital fingerprints or semantic vector representations of the existing content, using a multi-stage approach;
determining, based at least on the similarity scores, whether the digital content is identical to at least one existing content, derivative of at least one existing content, or potentially a deepfake of at least one existing content;
storing the digital fingerprints, the metadata, the CID, in a configuration after being signed, or results of generating or verifying the digital content to be identical, derivative, or deepfake of the at least one existing content, on a decentralized storage system, wherein the decentralized storage system is one of a distributed database system, a blockchain, or a hybrid of a database-blockchain system, the decentralized storage system providing at least two storage levels with different access and immutability characteristics, wherein the at least two storage levels provide distributed storage for availability, and immutable registry of cryptographic proofs of available digital contents;
generating an output to indicate at least one match between the digital content and the at least one existing content, the output further including at least one of the similarity scores, the author or the content holder, a declaration indicating whether the digital content is human-created or AI-generated or other metadata, or reference links to the decentralized storage system; and
updating the decentralized storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

2. The method according to claim 1, wherein
parameters for generating the digital fingerprints including sensitivity to one or more of resizing, compression, and audio speed variations are adjustable in order to optimize a robustness or tolerance of the digital content to specific transformations, and
adjusting the parameters modifies algorithms for extraction of the digital fingerprints without altering the content itself.

3. The method according to claim 1, wherein determining whether the digital content is the identical, derivative, or deepfake of the at least one existing content comprises performing a cascade process that includes:
initial filtering of the digital content with sub-linear complexity to reduce candidates from among the existing content,
comparing, using multiple weighted metrics, the digital content to the candidates,
identifying one or more of the candidates having at least a threshold level of similarity to the digital content as the at least one existing content, and
providing an alert or a report signaling that the digital content is the identical, derivative, or deepfake of the at least one existing content.

4. The method according to claim 1, wherein at least one Application Programming Interfaces (APIs) or a Model Context Protocol (MCP) is used in association with the large language models or A2A for agent-to-agent communication, or applying other system integration or communication protocols to autonomously register created content using cryptographic identification of the model and optionally including generation parameters in attestation, to verify its originality against pre-existing works, and to declare the author, where this is permitted.

5. The method according to claim 1, further comprising:
securely storing cryptographic keys used for signing the digital fingerprints in a manner that avoids a plaintext storage of the cryptographic keys, using at least one of key-at-rest encryption techniques and hardware protection mechanisms.

6. The method according to claim 1, wherein the at least two storage levels with different access and immutability characteristics for storing the digital fingerprints, the metadata, the CID after being signed, or the results of determining the digital content to be identical, derivative, or deepfake of the at least one existing content, includes:
a first level having a cache memory for rapid access to frequently used data,
a second level having a distributed storage system with replication for availability, and
a third level having an immutable registry for cryptographic proofs and references, wherein the data migrates between levels based on access patterns and verification requirements.

7. The method according to claim 1, further comprising:
using indexed data structures and similarity search procedures with sub-linear complexity in computing the similarity scores to enable faster determination of the digital content as the identical, derivative, or deepfake of the at least one existing content, and providing a probability score indicating a degree of correspondence of the digital content to one of being identical, derivative, or deepfake of the at least one existing content.

8. The method according to claim 1, wherein when the author or rights holder does not possess a personal cryptographic key, generating the digital signature comprises:
authenticating the author or rights holder through an identity verification mechanism comprising at least one of platform credentials with multi-factor authentication, a third-party identity provider, or a hardware-backed authentication protocol;
the system generating or retrieving a cryptographic key associated with the authenticated identity of the author or rights holder; and
creating a signed attestation record binding the authenticated identity to the CID, wherein the attestation record comprises at least the authenticated identity, an authentication method identifier, a timestamp, and the CID, and wherein the signed attestation record provides non-repudiation by cryptographically linking the authenticated identity to approval of the digital content.

9. A system for verifying authenticity, integrity and non-repudiation of digital content and identifying similarity to existing digital content without a trusted central authority, the system comprising:
at least one storage system;
at least one memory having computer-readable instructions stored therein; and
at least one processor coupled to the at least one storage system and the at least one memory, the at least one processor being configured to execute the computer-readable instructions to:
receive a digital content and, optionally, associated metadata, wherein the digital content has at least one of an author or a rights holder, including automated systems;
preprocess the digital content based on a file type of the digital content, wherein the preprocessing includes performing normalization and standardization operations on the digital content to improve extraction of digital fingerprint of the digital content;
generate at least one of the digital fingerprints or semantic vector representations for the digital content through parallel processing via content-specific dedicated processes, wherein the digital fingerprints or the semantic vector representation:
are resistant to alterations; and
include at least perceptual hashing algorithms, robust feature extraction, or semantic analysis using multimodal models or Large Language Models;
generate a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content;
generate or verify a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content;
compute at least one similarity score between the digital content and existing content accessible by the system by comparing the digital fingerprints or the semantic vector representations of the digital content with available digital fingerprints or semantic vector representations of the existing content, using a multi-stage approach;
determine, based at least on the similarity scores, whether the digital content is identical to at least one existing content, derivative of at least one existing content, or potentially a deepfake of at least one existing content;
store the digital fingerprints, the metadata, the CID, in a configuration, after being signed, or results of generating or verifying the digital content to be identical, derivative, or deepfake of the at least one existing content, on the at least one storage system, wherein the at least one storage system includes one of a distributed database system, a blockchain, or a hybrid of a database-blockchain system, the at least one storage system providing at least two storage levels with different access and immutability characteristics, wherein the at least two storage levels provide distributed storage for availability, and immutable registry of cryptographic proofs of available digital contents;
generate an output to indicate at least one match between the digital content and the at least one existing content, the output further including at least one of the similarity scores, the author or the content holder, a declaration indicating whether the digital content is human-created or AI-generated, or reference links to the at least one storage system; and
update the at least one storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

10. The system of claim 9, wherein
parameters for generating the digital fingerprints including sensitivity to one or more of resizing, compression, and audio speed variations are adjustable in order to optimize a robustness or tolerance of the digital content to specific transformations, and
the at least one processor is configured to adjust the parameters by modifying algorithms for extraction of the digital fingerprints without altering the content itself.

11. The system of claim 9, wherein the at least one processor is configured to determine whether the digital content is the identical, derivative, or deepfake of the at least one existing content comprises performing a cascade process that includes:
initial filtering of the digital content with sub-linear complexity to reduce candidates from among the existing content,
comparing, using multiple weighted metrics, the digital content to the candidates,
identifying one or more of the candidates having at least a threshold level of similarity to the digital content as the at least one existing content, and
providing an alert or a report signaling that the digital content is the identical, derivative, or deepfake of the at least one existing content.

12. The system of claim 9, wherein at least one Application Programming Interfaces (APIs) or a Model Context Protocol (MCP) is used in association with the large language models or A2A for agent-to-agent communication, to autonomously register created content using cryptographic identification of the model and optionally including generation parameters in attestation, to verify its originality against pre-existing works, and to declare the author, where this is permitted.

13. The system of claim 9, wherein the at least one processor is further configured to:
securely store cryptographic keys used for signing the digital fingerprints in a manner that avoids a plaintext storage of the cryptographic keys, using at least one of key-at-rest encryption techniques and hardware protection mechanisms.

14. The system of claim 9, wherein the at least two storage levels with different access and immutability characteristics for storing the digital fingerprints, the metadata, the CID after being signed, or the results of determining the digital content to be identical, derivative, or deepfake of the at least one existing content, includes:
a first level having a cache memory for rapid access to frequently used data,
a second level having a distributed storage system with replication for availability, and
a third level having an immutable registry for cryptographic proofs and references, wherein the data migrates between levels based on access patterns and verification requirements.

15. The system of claim 9, wherein the at least one processor is further configured to:
use indexed data structures and similarity search procedures with sub-linear complexity in computing the similarity scores to enable faster determination of the digital content as the identical, derivative, or deepfake of the at least one existing content, and providing a probability score indicating a degree of correspondence of the digital content to one of being identical, derivative, or deepfake of the at least one existing content.

16. One or more non-transitory computer-readable media comprising computer-readable instructions, which when executed by one or more processors of a system for verifying authenticity, integrity and non-repudiation of digital content and identifying similarity to existing digital content without a trusted central authority, causes the system to:
receive a digital content and, optionally, associated metadata, wherein the digital content has at least one of an author or a rights holder, including automated systems;
preprocess the digital content based on a file type of the digital content, wherein the preprocessing includes performing normalization and standardization operations on the digital content to improve extraction of digital fingerprint of the digital content;
generate at least one of the digital fingerprints or semantic vector representations for the digital content through parallel processing via content-specific dedicated processes, wherein the digital fingerprints or the semantic vector representation:
are resistant to alterations; and
include at least perceptual hashing algorithms, robust feature extraction, or semantic analysis using multimodal models or Large Language Models;
generate a Content Identifier (CID) for the digital content which is either the digital fingerprint of the digital content, or a cryptographic hash derived from the digital fingerprint combined with the metadata, constituting a unique and self-verifying reference that can be independently recalculated to verify the authenticity of the digital content;
generate or verify a digital signature for the author or the rights holder, wherein the digital signature of the author or the rights holder is applied to the CID creating an inseparable cryptographic binding between the author or the rights holder and the digital content, to ensure non-repudiation, integrity, and authenticity of the digital content;
compute at least one similarity score between the digital content and existing content accessible by the system by comparing the digital fingerprints or the semantic vector representations of the digital content with available digital fingerprints or semantic vector representations of the existing content, using a multi-stage approach;
determine, based at least on the similarity scores, whether the digital content is identical to at least one existing content, derivative of at least one existing content, or potentially a deepfake of at least one existing content;
store the digital fingerprints, the metadata, the CID, in a configuration, after being signed, or results of generating or verifying the digital content to be identical, derivative, or deepfake of the at least one existing content, on at least one storage system, wherein the at least one storage system includes one of a distributed database system, a blockchain, or a hybrid of a database-blockchain system, the at least one storage system providing at least two storage levels with different access and immutability characteristics, wherein the at least two storage levels provide distributed storage for availability, and immutable registry of cryptographic proofs of available digital contents;
generate an output to indicate at least one match between the digital content and the at least one existing content, the output further including at least one of the similarity scores, the author or the content holder, a declaration indicating whether the digital content is human-created or AI-generated, or reference links to the at least one storage system; and
update the at least one storage system with any modifications of the metadata and resolution of conflicts based on multi-factor analysis that includes cryptographic evidence, timestamp, declaration of human or AI authorship ,similarity evaluation associated with the digital content to establish priority or legitimacy information of the author or the content holder of the digital content.

17. The one or more non-transitory computer-readable media of claim 16, wherein
parameters for generating the digital fingerprints including sensitivity to one or more of resizing, compression, and audio speed variations are adjustable in order to optimize a robustness or tolerance of the digital content to specific transformations, and
the at least one processor is configured to adjust the parameters by modifying algorithms for extraction of the digital fingerprints without altering the content itself.

18. The one or more non-transitory computer-readable media of claim 16, wherein execution of the computer-readable instructions by the one or more processors further cause the system to determine whether the digital content is the identical, derivative, or deepfake of the at least one existing content comprises performing a cascade process that includes:
initial filtering of the digital content with sub-linear complexity to reduce candidates from among the existing content,
comparing, using multiple weighted metrics, the digital content to the candidates,
identifying one or more of the candidates having at least a threshold level of similarity to the digital content as the at least one existing content, and
providing an alert or a report signaling that the digital content is the identical, derivative, or deepfake of the at least one existing content.

19. The one or more non-transitory computer-readable media of claim 16, wherein at least one Application Programming Interfaces (APIs) or a Model Context Protocol (MCP) is used in association with the large language models or A2A for agent-to-agent communication, to autonomously register created content using cryptographic identification of the model and optionally including generation parameters in attestation, to verify its originality against pre-existing works, and to declare the author, where this is permitted.

20. The one or more non-transitory computer-readable media of claim 16, wherein execution of the computer-readable instructions by the one or more processors further cause the system to:
securely store cryptographic keys used for signing the digital fingerprints in a manner that avoids a plaintext storage of the cryptographic keys, using at least one of key-at-rest encryption techniques and hardware protection mechanisms.
